(19) United States
(12) Patent Application Publication
(10) Pub. No.: US 2007/0097036 A1
(43) Pub. Date: May 3, 2007

(54) Plasma display apparatus and method of driving the same

(76) Inventors: Jeong Pil Choi, Suwon-si (KR); Beong Ha Lim, Gumi-si (KR)

Correspondence Address: KED & ASSOCIATES, LLP, P.O. Box 221200, Chantilly, VA, 20153-1200, US

(21) Appl. No.: 11/589,289

(22) Filed: Oct. 30, 2006

(30) Foreign Application Priority Data
Oct. 31, 2005 (KR) 10-2005-0103538

(51) Int. Cl. G09G 3/28

(52) U.S. Cl. 345/68

(57) ABSTRACT

A plasma display apparatus is disclosed. The plasma display apparatus includes a plasma display panel including a scan electrode, and a scan driver. The scan driver charges a first capacitor to a first voltage charged to a source capacitor, and supplies a setup pulse having a voltage equal to a sum of the first voltage charged to the first capacitor and a setup voltage to the scan electrode.

This Nonprovisional application claims priority under 35 U.S.C. § 119(a) on Patent Application No. 10-2005-0103538 filed in Korea on Oct. 31, 2005 the entire contents of which are hereby incorporated by reference.

### BACKGROUND

1. Field

This document relates to a plasma display apparatus and a method of driving the same.

2. Description of the Background Art

Plasma display panels display images by exciting phosphors using ultraviolet rays generated when discharging a mixed inert gas such as a mixture of Ne and Xe, a mixture of Ne and Xe, a mixture of He, Xe, and Ne.

FIG. 1 illustrates a subfield pattern of 8-bit default code for displaying an image of 256 gray levels on a plasma display panel.

As illustrated in FIG. 1, the plasma display panel is driven in a time-division manner with a frame being divided into several subfields having a different number of emission times.

Each subfield is subdivided into a reset period for initializing the whole screen, an address period for sequentially selecting scan lines and for selecting discharge cells in the selected scan lines, and a sustain period for representing a gray level in accordance with the number of discharge times.

For example, if an image with 256-level gray level is to be displayed, a frame period (for example, 16.67 ms) corresponding to 1/60 sec is divided into eight subfields SF1 to SF8. Each of the eight subfields SF1 to SF8 is subdivided into a reset period, an address period, and a sustain period. The duration of the reset period in a subfield is equal to the duration of the reset periods in the other subfields. The duration of the address period in a subfield is equal to the duration of the address periods in the other subfields. On the other hand, the duration of the sustain period and the number of sustain pulses in a sustain period increase in a ratio of 2ⁿ (where, n=0, 1, 2, 3, 4, 5, 6, 7) in each of the subfields.

FIG. 2 illustrates a driving waveform of a related art plasma display apparatus.

As illustrated in FIG. 2, each subfield SF is divided into a reset period RP for initializing discharge cells of the whole screen, an address period AP for selecting cells to be discharged, and a sustain period SP for maintaining a discharge of the selected discharge cells.

The reset period RP is further divided into a setup period SU and a set-down period SD. During the setup period SU, a rising pulse PR is simultaneously supplied to all scan electrodes Y, thereby generating a weak discharge (i.e., a setup discharge) within the discharge cells of the whole screen. This results in the formation of wall charges inside the discharge cells. During the set-down period SD, a falling pulse NR, which falls from a positive sustain voltage Vs lower than the highest voltage of the rising pulse PR to a scan voltage −Vy of a negative polarity with a predetermined slope, is supplied to the scan electrodes Y, thereby generating a weak erase discharge (i.e., a set-down discharge) within the discharge cells. The set-down discharge erases wall charges and space charges generated by the set-up discharge such that the remaining wall charges are uniform inside the discharge cells to the extent that an address discharge can be stably performed.

During the address period AP, a scan pulse SCNP of a negative polarity is sequentially supplied to the scan electrodes Y and, at the same time, a data pulse DP of a positive polarity is selectively supplied to the address electrodes X in synchronization with the scan pulse. As the voltage difference between the scan pulse SCNP and the data pulse DP is added to the wall voltage generated during the reset period, the address discharge is generated within the discharge cells to which the data pulse DP is supplied. Wall charges are formed inside the cells selected by performing the address discharge.

A positive sustain voltage Vs is supplied to the sustain electrodes Z during the set-down period SD and the address period AP.

During the sustain period SP, sustain pulses SUSP are alternately supplied to the scan electrodes Y and the sustain electrodes Z. As the wall voltage within the cells selected by performing the address discharge is added to the sustain pulse SUSP, every time the sustain pulse SUSP is supplied, a sustain discharge in the form of a display discharge is generated between the scan electrodes Y and the sustain electrodes Z.

FIG. 3 illustrates an erroneous discharge generated during a setup period in the driving waveform of FIG. 2.

The setup pulse supplied during the setup period SU sharply rises to the sustain voltage Vs of around 200 V, and then rises to a setup peak voltage (Vs+Vst) with a predetermined slope.

However, since the setup pulse sharply rises to the sustain voltage Vs having a high voltage around 200 V, an erroneous discharge may occur during the setup period SU. This results in a reduction in a contrast ratio of the plasma display apparatus.

More specifically, a normal setup discharge, as illustrated in FIG. 3, occurs using the setup peak voltage (Vs+Vst) at a time point B after a predetermined duration of time from the supplying the sustain voltage Vs. However, a setup erroneous discharge occurs using only the sustain voltage Vs at a time point A depending on a state of discharge cells of a previous subfield.

### SUMMARY

In one aspect, a plasma display apparatus comprises a plasma display panel including a scan electrode, and a scan driver that charges a first capacitor to a first voltage charged to a source capacitor, and supplies a setup pulse having a voltage equal to a sum of the first voltage charged to the first capacitor and a setup voltage to the scan electrode.

In another aspect, a method of driving a plasma display apparatus, which is driven with each of a plurality of subfields being divided into a reset period, an address period, and a sustain period, the method comprises supplying a setup pulse gradually rising from a first voltage to a setup peak voltage to a scan electrode during a setup period of the reset period, wherein the first voltage is less than a voltage of a sustain pulse supplied to the scan electrode during the sustain period, and supplying a set-down pulse to the scan electrode during a set-down period of the reset period, wherein the set-down pulse sharply falls from the setup peak voltage to the voltage of the sustain pulse, and then gradually falls from the voltage of the sustain pulse to a predetermined voltage level.

In still another aspect, a method of driving a plasma display apparatus, which is driven with each of a plurality of subfields being divided into a reset period, an address period, and a sustain period, the method comprises supplying a setup pulse gradually rising from a first voltage to a setup peak voltage to a scan electrode during a setup period of the reset period, wherein the first voltage is less than a voltage of a sustain pulse supplied to the scan electrode during the sustain period, and supplying a set-down pulse to the scan electrode during a set-down period of the reset period, wherein the set-down pulse sharply falls from the setup peak voltage to the first voltage, and then gradually falls from the first voltage to a predetermined voltage level.

Implementations may include one or more of the following features. For example, the first voltage may be substantially equal to one half a sustain voltage.

The first voltage may be supplied to the scan electrode during a reset period of at least one subfield of a plurality of subfields.

The first voltage charged to a source capacitor of an energy recovery circuit may be supplied to the scan electrode.

The setup pulse may be maintained at the highest voltage level of the setup pulse for a predetermined duration of time.

It is to be understood that both the foregoing general description and the following detailed description are exemplary and explanatory and are intended to provide further explanation of the invention as claimed.

### BRIEF DESCRIPTION OF THE DRAWINGS

The accompany drawings, which are included to provide a further understanding of the invention and are incorporated in and constitute a part of this specification, illustrate embodiments of the invention and together with the description serve to explain the principles of the invention.

FIG. 1 illustrates a subfield pattern of 8-bit default code for displaying an image of 256 gray levels on a plasma display panel;

FIG. 2 illustrates a driving waveform of a related art plasma display apparatus;

FIG. 3 illustrates an erroneous discharge generated during a setup period in the driving waveform of FIG. 2;

FIG. 4 illustrates a plasma display apparatus according to an embodiment;

FIG. 5 illustrates a driving circuit included in a scan driver of the plasma display apparatus according to the embodiment;

FIG. 6 illustrates a driving waveform generated through an operation of the driving circuit of the scan driver in FIG. 5; and

FIGS. 7a and 7b illustrate a setup pulse in the driving waveform of FIG. 6, and switch timing for generating the setup pulse.

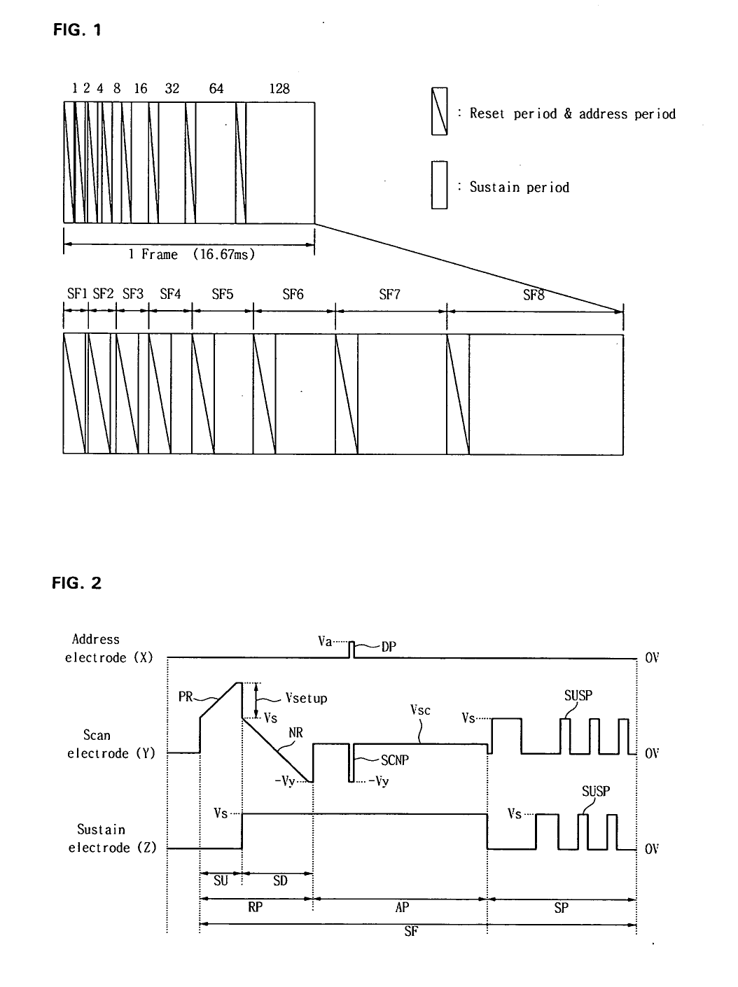

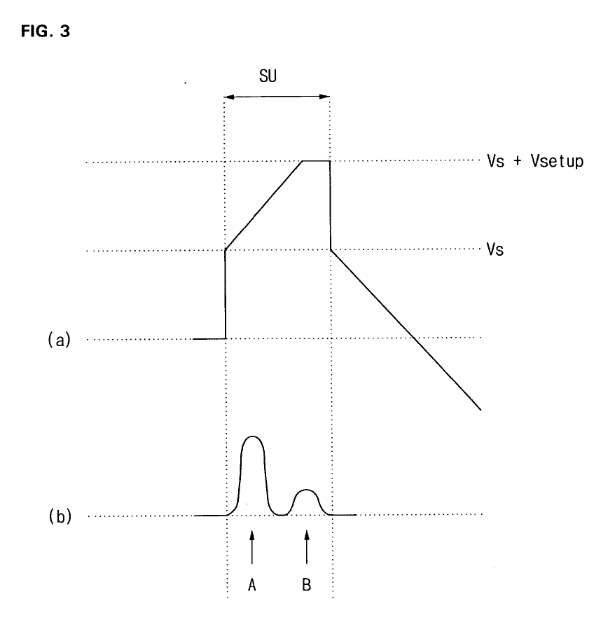

### DETAILED DESCRIPTION OF PREFERRED EMBODIMENTS

Preferred embodiments of the present invention will be described in a more detailed manner with reference to the drawings.

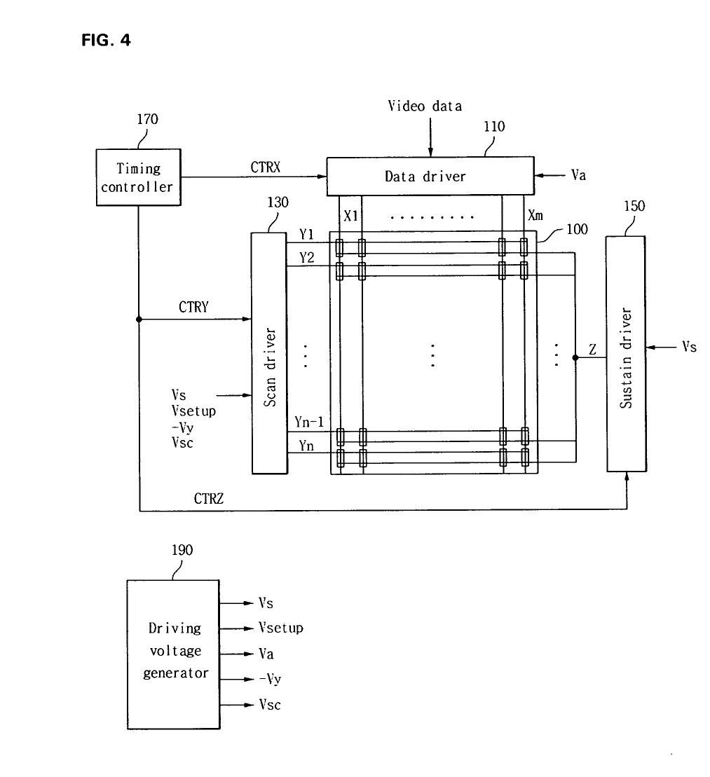

FIG. 4 illustrates a plasma display apparatus according to an embodiment.

Referring to FIG. 4, the plasma display apparatus according to the embodiment includes a plasma display panel 100, a data driver 110, a scan driver 130, a sustain driver 150, a timing controller 170, and a driving voltage generator 190.

The plasma display panel 100 includes a front panel (not shown) and a rear panel (not shown), which are coalesced with each other at a given distance. On the front panel, a plurality of electrodes, for example, scan electrodes Y1 to Yn and sustain electrodes Z are formed in pairs. On the rear panel, address electrodes X1 to Xm are formed to intersect the scan electrodes Y1 to Yn and the sustain electrodes Z.

The data driver 110 receives data mapped for each subfield by a subfield mapping circuit (not shown) after being inverse-gamma corrected and error-diffused through an inverse gamma correction circuit (not shown) and an error diffusion circuit (not shown), or the like. The data driver 110, under the control of the timing controller 170 samples and latches the mapped data, and then supplies the data to the address electrodes X1 to Xm.

The scan driver 130, under the control of the timing controller 170, supplies a reset pulse for initializing the whole screen to the scan electrodes Y1 to Yn during a reset period. The reset pulse includes at least one of a rising pulse with a gradually rising voltage or a falling pulse with a gradually falling voltage. The scan driver 130 supplies a scan reference voltage Vsc and a scan pulse to the scan electrodes Y1 to Yn during an address period, thereby selecting scan lines. The scan pulse falls from the scan reference voltage Vsc to a predetermine voltage (−Vy)

The scan driver 130 supplies a sustain pulse to the scan electrodes Y1 to Yn during a sustain period, thereby generating a sustain discharge in discharge cells selected during the address period.

The sustain driver 150, under the control of the timing controller 170, supplies a positive Z-bias voltage Vs to the sustain electrodes Z during at least a portion of the reset period. Then, the sustain driver 150 supplies a sustain pulse to the sustain electrodes Z during a sustain period. The sustain driver 150 and the scan driver 130 alternately operate.

The timing controller 170 receives a vertical/horizontal synchronization signal, and a clock signal, and generates timing control signals CTRX, CTRY and CTRZ required in each driver 110, 130 and 150. The timing controller 170 supplies the timing control signals CTRX, CTRY and CTRZ to the corresponding drivers 110, 130 and 150, thereby controlling each of the drivers 110, 130 and 150.

The timing control signal CTRX supplied to the data driver 110 includes a sampling clock for sampling data, a latch control signal, and a switch control signal for controlling the on/off time of an energy recovery circuit and a driving switch element. The timing control signal CTRY supplied to the scan driver 130 includes a switch control signal for controlling the on/off time of the energy recovery circuit and the driving switch element inside the scan driver 130. The timing control signal CTRZ supplied to the sustain driver 150 includes a switch control signal for controlling the on/off time of the energy recovery circuit and the driving switch element inside the sustain driver 150.

The driving voltage generator 190 generates various driving voltages necessary to each driver 110, 130 and 150, for example, a sustain voltage Vs, a setup voltage Vsetup, a Z-bias voltage Vs, a data voltage Va, a set-down voltage −Vy, a scan voltage −Vy, a scan reference voltage Vsc. These driving voltages may vary with the composition of a discharge gas or the structure of the discharge cell.

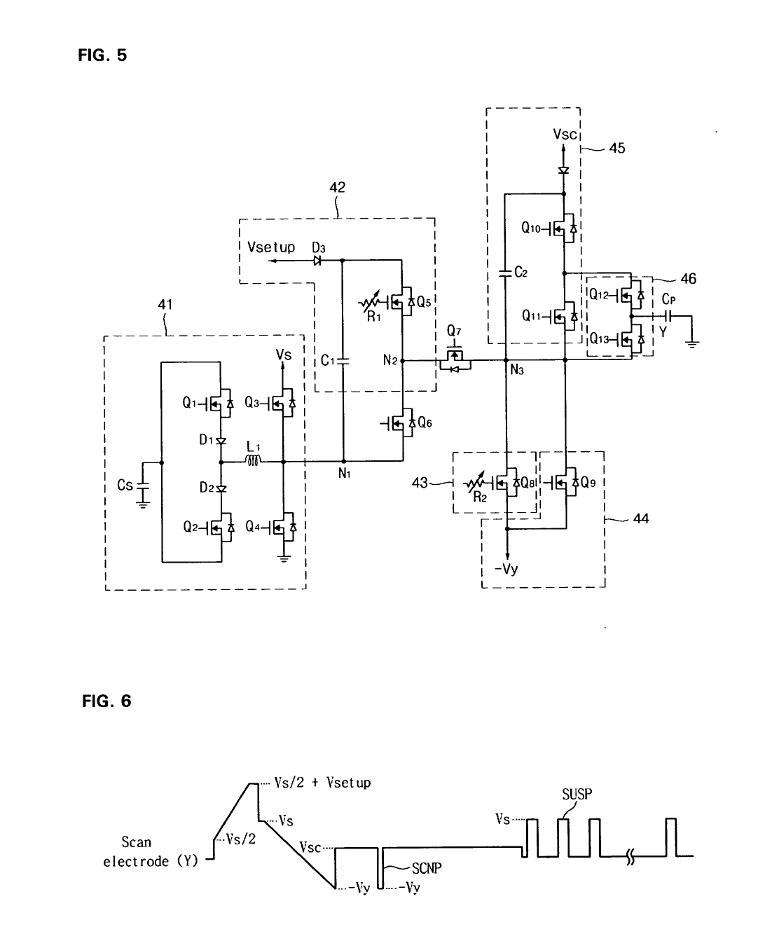

FIG. 5 illustrates a driving circuit included in a scan driver of the plasma display apparatus according to the embodiment. FIG. 6 illustrates a driving waveform generated through an operation of the driving circuit of the scan driver in FIG. 5.

Referring to FIGS. 5 and 6, the plasma display apparatus according to the embodiment includes a plasma display panel Cp including the scan electrodes Y, and the scan driver. The scan driver supplies a setup pulse, which gradually rises from a setup bias voltage equal to one half the sustain voltage Vs to a setup peak voltage, to the scan electrode Y during a setup period of at least one subfield.

The plasma display panel in FIG. 5 is a panel capacitor Cp for equivalently indicating a capacitance formed between the scan electrode Y and the sustain electrode (not illustrated).

The scan driver includes an energy recovery circuit 41, a drive integrated circuit (IC) 46, a setup supply unit 42, a set-down supply unit 43, a scan voltage supply unit 44, a scan reference voltage supply unit 45, a seventh switch Q7 connected between the setup supply unit 42 and the drive IC 46, and a sixth switch Q6 connected between the setup supply unit 42 and the energy recovery circuit 41.

The drive IC 46 is connected to the scan electrode Y in a push-pull manner. The drive IC 46 includes a twelfth switch Q12 and a thirteenth switch Q13 for receiving voltage signals from the energy recovery circuit 41, the setup supply unit 42, the set-down supply unit 43, the scan voltage supply unit 44, and the scan reference voltage supply unit 45. An output line between the twelfth switch Q12 and the thirteenth switch Q13 is connected to any one of the scan electrode lines.

The energy recovery circuit 41 includes a source capacitor Cs, a first inductor L1, a first switch Q1, a first diode D1, a second diode D2, and a second switch Q2. The source capacitor Cs is charged to energy recovered from the scan electrode Y. The first inductor L1 is connected between the source capacitor Cs and the drive IC 46. The first switch Q1, the first diode D1, the second diode D2, and the second switch Q2 are connected between the source capacitor Cs and the first inductor L1 in parallel.

The following is a detailed description of an operation process of the energy recovery circuit 41.

Assuming that the source capacitor Cs is charged to a first voltage, that is lower than a voltage of a sustain pulse, preferably, to a voltage level Vs/2 equal to one half the sustain voltage Vs.

When the first switch Q1 is turned on, the charging voltage to the source capacitor Cs is supplied to the drive IC 46 through the first switch Q1, the first diode D1, the first inductor L1, an internal diode of the sixth switch Q6, and the seventh switch Q7, and then the voltage supplied to the drive IC 46 is supplied to the scan electrode Y. At this time, the first inductor L1 and the panel capacitor Cp form a series LC resonance circuit such that the sustain voltage Vs is supplied to the scan electrode Y.

Next, when the third switch is turned on, the sustain voltage Vs is supplied to the drive IC 46 through the internal diode of the sixth switch Q6 and the seventh switch Q7, and then the sustain voltage Vs supplied to the drive IC 46 is supplied to the scan electrode Y. Thus, a voltage level of the scan electrode Y is maintained at the sustain voltage Vs such that the sustain discharge occurs in the discharge cells.

After the sustain discharge occurs in the discharge cells, the second switch Q2 is turned on. When the second switch Q2 is turned on, a reactive energy is recovered from the panel capacitor Cp through the scan electrode Y, the drive IC 46, an internal diode of the seventh switch Q7, the sixth switch Q6, the first inductor L1, the second diode D2, and the second switch Q2, and then the reactive energy is stored in the source capacitor Cs. Subsequently, the fourth switch Q4 is turned on such that the voltage level of the scan electrode Y is maintained at a ground level voltage GND.

As above, the energy recovery circuit 41 recovers the reactive energy from the panel capacitor Cp. Then, a voltage is supplied to the scan electrode Y using the recovered reactive energy, thereby reducing power consumption when a discharge occurs during the setup period and the sustain period.

The scan voltage supply unit 44 includes a ninth switch Q9 connected between a third node N3 and a scan voltage source (−Vy). The ninth switch Q9 is switched on in response to a control signal supplied by the timing controller (not illustrate) during the address period such that the scan voltage −Vy is supplied to the drive IC 46.

The scan reference voltage supply unit 45 includes a second capacitor C2, a tenth switch Q10, and an eleventh switch Q11 which are connected between a scan reference voltage source (Vsc) and the third node N3. The tenth switch Q10 and the eleventh switch Q11 are switched on in response to a control signal supplied by the timing controller (not illustrate) during the address period such that a voltage of the scan reference voltage source (Vsc) is supplied to the drive IC 46. The second capacitor C2 supplies a sum of a voltage supplied to the third node N3 and the voltage of the scan reference voltage source (Vsc) to the tenth switch Q10.

The set-down supply unit 43 includes an eighth switch Q8 connected between the third node N3 and the scan voltage source (−Vy). The set-down supply unit 43 gradually lowers a voltage supplied to the drive IC 46 during a set-down period of the reset period to the scan voltage (−Vy) with a predetermined slope.

The setup supply unit 42 includes a third diode D3 and a fifth switch Q5 connected between a setup voltage source (Vsetup) and a first node N1, and a first capacitor C1 connected between the setup voltage source (Vsetup) and the energy recovery circuit 41. The third diode D3 prevents an inverse current flowing from the first capacitor C1 to the setup voltage source (Vsetup). The first capacitor C1 supplies a sum of the first voltage supplied by the energy recovery circuit 41 and a voltage of the setup voltage source (Vsetup) to the fifth switch Q5. The fifth switch Q5 is switched on in response to a control signal supplied by the timing controller during the reset period, thereby supplying a setup peak voltage to a second node N2. In such a case, the fifth switch Q5 is turned on for a predetermined duration of time so that the setup peak voltage is supplied for a predetermined duration.

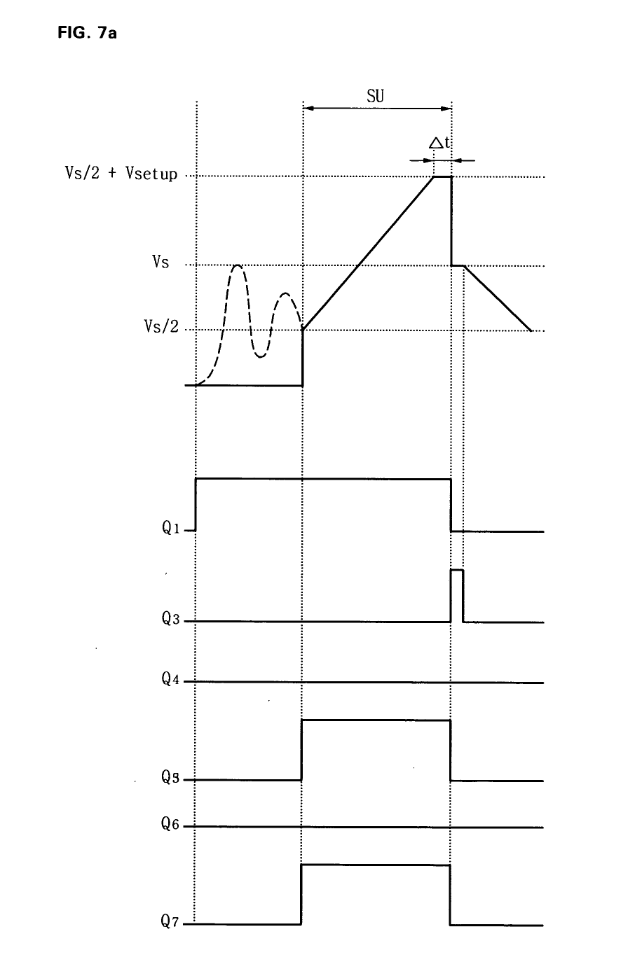

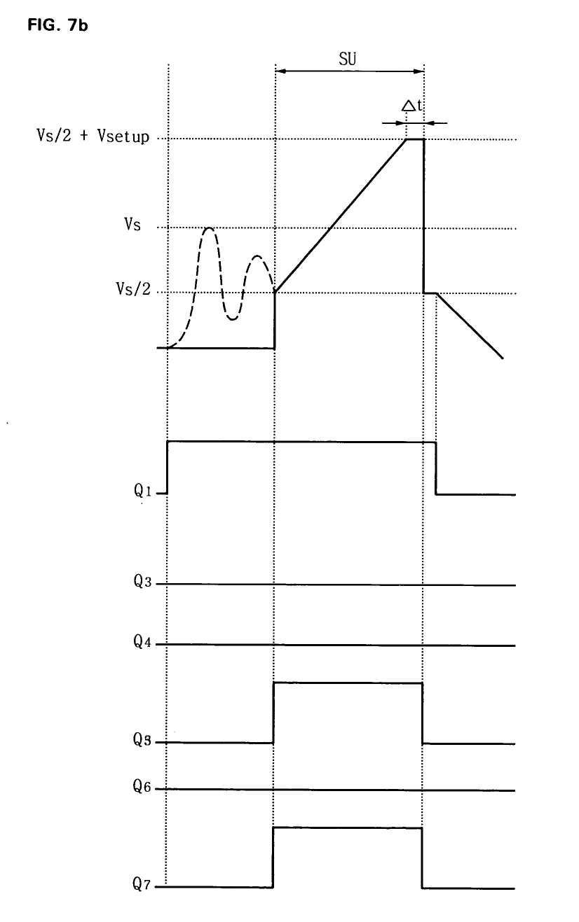

This process will be described below with reference to FIGS. 7a and 7b.

FIGS. 7a and 7b illustrate a setup pulse in the driving waveform of FIG. 6, and switch timing for generating the setup pulse.

Referring FIG. 7a, when the first switch Q1 is turned on, the charging voltage (i.e., one half Vs/2 the sustain voltage Vs) to the source capacitor Cs is supplied to the first node N1 through the source capacitor Cs, the first switch Q1, the first diode D1, and the first inductor L1. Therefore, a voltage of the first node N1 is equal to one half Vs/2 the sustain voltage Vs. At this time, it is preferable that the first switch Q1 remains in the turn-on state for a predetermined duration of time so that the voltage of the first node N1 remains in a normal state.

Next, when the fifth switch Q5 and the seventh switch Q7 are turned on in the turn-on state of the first switch Q1, the voltage Vs/2 supplied to the first node N1 is supplied to the scan electrode Y through the internal diode of the sixth switch Q6, the seventh switch Q7, and the drive In 46. Therefore, the voltage of the scan electrode Y rises to the voltage Vs/2 equal to one half the sustain voltage Vs.

Since the negative sustain voltage −Vs is supplied to the first capacitor C1, the second capacitor C2 supplies the voltage (Vs+Vsetup) to the fifth switch Q5.

While a variable resistor R1 installed in front of the fifth switch Q5 controls the channel width, the fifth switch Q5 supplies the charging voltage to the first capacitor C1 to the second node N2 with a predetermined slope. The voltage supplied to the second node N2 is supplied to the scan electrode Y through the seventh switch Q7 and the drive IC 46.

As a result, the setup pulse gradually rising from the voltage Vs/2 (i.e., the first voltage) to the setup peak voltage (Vs/2+Vst) is supplied to the scan electrode Y. In such a case, the fifth switch Q5 and the seventh Q7 are turned on for a predetermined period of time Δt so that the setup pulse is maintained at the setup peak voltage (Vs/2+Vst) for a predetermined period of time.

After supplying the setup pulse to the scan electrode Y, the fifth switch Q5 is turned off and the third switch Q3 is turned on. Only the sustain voltage Vs supplied by the energy recovery circuit 41 is supplied to the second node N2, and thus the voltage of the scan electrode Y falls to the sustain voltage Vs.

Switch timing for generating the setup pulse in FIG. 7b is the same as the switch timing for generating the setup pulse in FIG. 7a. In FIG. 7b, after supplying the setup pulse to the scan electrode Y, the third switch Q3, the fifth switch Q5, and the seventh switch Q7 are turned off and the first switch Q1 is turned on for a predetermined duration of time, so that the set-down pulse, which sharply falls to the voltage Vs/2 (i.e., the first voltage) and then gradually falls from the voltage Vs/2, is supplied to the scan electrode Y.

In FIGS. 7a and 7b, the setup pulse gradually rising from the first voltage to the setup peak voltage may be supplied to the scan electrode during a setup period of at least one subfield of a plurality of subfields.

Accordingly, the reset discharge stably occurs during the setup period without a reset erroneous discharge.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A plasma display apparatus, comprising:
a plasma display panel including a scan electrode; and
a scan driver that charges a first capacitor to a first voltage charged to a source capacitor, and supplies a setup pulse having a voltage equal to a sum of the first voltage charged to the first capacitor and a setup voltage to the scan electrode.

2. The plasma display apparatus of claim 1, wherein the first voltage is substantially equal to one half a sustain voltage.

3. The plasma display apparatus of claim 1, wherein the first voltage is supplied to the scan electrode during a reset period of at least one subfield of a plurality of subfields.

4. The plasma display apparatus of claim 1, wherein the scan driver includes
an energy recovery circuit that charges the first capacitor to the first voltage charged to the source capacitor, and
a setup supply unit that supplies the setup pulse having the voltage equal to a sum of the first voltage charged to the first capacitor and the setup voltage to the scan electrode.

5. The plasma display apparatus of claim 4, wherein the scan driver turns off a seventh switch connected between the setup supply unit and the scan electrode so that the first voltage is not supplied to the scan electrode during the charging of the first capacitor to the first voltage.

6. The plasma display apparatus of claim 4, wherein the scan driver turns on an ER-UP switch and an ER-DOWN switch during the charging of the first capacitor to the first voltage.

7. The plasma display apparatus of claim 1, wherein the scan driver supplies a set-down pulse, which sharply falls from a setup peak voltage to a sustain voltage and then gradually falls from the sustain voltage, to the scan electrode during a set-down period of a reset period.

8. The plasma display apparatus of claim 1, wherein the scan driver supplies a set-down pulse, which sharply falls from a setup peak voltage to the first voltage and then gradually falls from the first voltage to a predetermined voltage level, to the scan electrode during a set-down period of a reset period.

9. The plasma display apparatus of claim 1, wherein the scan driver maintains the highest voltage of the setup pulse for a predetermined duration of time.

10. A method of driving a plasma display apparatus, which is driven with each of a plurality of subfields being divided into a reset period, an address period, and a sustain period, the method comprising:
supplying a setup pulse gradually rising from a first voltage to a setup peak voltage to a scan electrode during a setup period of the reset period, wherein the first voltage is less than a voltage of a sustain pulse supplied to the scan electrode during the sustain period; and
supplying a set-down pulse to the scan electrode during a set-down period of the reset period, wherein the set-down pulse sharply falls from the setup peak voltage to the voltage of the sustain pulse, and then gradually falls from the voltage of the sustain pulse to a predetermined voltage level.

11. The method of claim 10, wherein the first voltage is substantially equal to one half the voltage of the sustain pulse.

12. The method of claim 10, wherein the first voltage is supplied to the scan electrode in at least one subfield of a plurality of subfields.

13. The method of claim 10, wherein the first voltage charged to a source capacitor of an energy recovery circuit is supplied to the scan electrode.

14. The method of claim 10, wherein the setup pulse is maintained at the highest voltage level of the setup pulse for a predetermined duration of time.

15. A method of driving a plasma display apparatus, which is driven with each of a plurality of subfields being divided into a reset period, an address period, and a sustain period, the method comprising:
supplying a setup pulse gradually rising from a first voltage to a setup peak voltage to a scan electrode during a setup period of the reset period, wherein the first voltage is less than a voltage of a sustain pulse supplied to the scan electrode during the sustain period; and
supplying a set-down pulse to the scan electrode during a set-down period of the reset period, wherein the set-down pulse sharply falls from the setup peak voltage to the first voltage, and then gradually falls from the first voltage to a predetermined voltage level.

16. The method of claim 15, wherein the first voltage is substantially equal to one half the voltage of the sustain pulse.

17. The method of claim 15, wherein the first voltage is supplied to the scan electrode in at least one subfield of a plurality of subfields.

18. The method of claim 15, wherein the first voltage charged to a source capacitor of an energy recovery circuit is supplied to the scan electrode.

19. The method of claim 15, wherein the setup pulse is maintained at the highest voltage level of the setup pulse for a predetermined duration of time.
